(19) United States
(12) Patent Application Publication
(10) Pub. No.: US 2013/0124256 A1
(43) Pub. Date: May 16, 2013

(54) METHOD AND SYSTEM FOR MONITORING PLANT ASSETS

(71) Applicant: YOKOGAWA ELECTRIC CORPORATION, Tokyo (JP)

(72) Inventor: Bijurai Pandiyath Velayudhan, Thrissur (IN)

(73) Assignee: YOKOGAWA ELECTRIC CORPORATION, Tokyo (JP)

(21) Appl. No.: 13/739,338

(22) Filed: Jan. 11, 2013

Related U.S. Application Data
(62) Division of application No. 12/510,339, filed on Jul. 28, 2009.

(30) Foreign Application Priority Data
Aug. 29, 2008 (SG) 2008-06402-4

(51) Int. Cl. G06Q 10/06

(52) U.S. Cl. CPC G06Q 10/0635
USPC 705/7.28

(57) ABSTRACT

The invention is a method and system for monitoring plant assets automatically comprising the steps of calculating a sum of the plant assets to be monitored, storing the calculated sum in a database, calculating a sum of the bad actors, computing the percentage of bad actors from the calculated sum, storing the computed percentage of bad actors into the database, calculating a current sum of the plant assets to be monitored after a predetermined interval, retrieving the stored sum of the plant assets, determining whether the current sum of the plant assets corresponds to the stored sum. When the stored sum corresponds to the current sum, the current sum of bad actors is calculated, the percentage of bad actors is computed from the calculated sum to determine an Asset Health Risk Index (“ARI”).

This application is a divisional application of U.S. patent application Ser. No. 12/510,339 filed Jul. 28, 2009, and is based upon and claims the benefits of priority from Singaporean Patent Application No. SG200806402-4 filed on Aug. 29, 2008, the entire contents of which being incorporated herein by reference.

### FIELD OF THE INVENTION

The invention relates to a method and system for monitoring the health of assets in a plant automatically.

### BACKGROUND OF THE INVENTION

In a typical plant, there are two types of assets; tangible and intangible assets. Tangible assets are field devices such as heat exchangers and pumps. Examples of intangible assets are process loops and PID Loops. Various diagnostics algorithms have been developed for identifying problems associated with the different types of plant assets.

In order to have an overview of the plant operational readiness and efficiency, the results of the various diagnostics algorithms are aggregated manually for the calculation of the health of the plant assets.

In the prior art, all the diagnostic data are listed in a Diagnostics layer. A user monitoring the plant assets has to review all the diagnostic data in the Diagnostic layer to identify whether each asset can be considered a Bad Actor. The number of assets identified as Bad Actors are then listed. The identified Bad Actors are aggregated manually for an overview of the plant operational readiness and efficiency. The user has to go through the full list to determine which maintenance activity is to be performed and how to perform.

Accordingly, there is a need for more efficient method to provide an overview of the plant operational readiness and efficiency.

### SUMMARY OF THE INVENTION

According to one embodiment of the present invention, there is provided a method for monitoring plant assets automatically comprising the steps of calculating a sum of the plant assets to be monitored, storing the calculated sum in a database, calculating a sum of the bad actors, computing the percentage of bad actors from the calculated sum, storing the computed percentage of bad actors into the database, calculating a current sum of the plant assets to be monitored after a predetermined interval, retrieving the stored sum of the plant assets, determining whether the current sum of the plant assets corresponds to the stored sum; and wherein the stored sum corresponds to the current sum. The method further includes the steps of, calculating the current sum of bad actors, computing the percentage of bad actors from the calculated sum, and determining an Asset Health Risk Index (“ARI”).

According to another embodiment of the invention, there is provided a method for monitoring plant assets automatically at predetermined intervals, in which the sum of the plant assets to be monitored and the sum of the bad actors in the last monitoring interval are stored in a database. The method comprises the steps of calculating a current sum of the plant assets to be monitored at the current predetermined interval, retrieving the stored sum of the plant assets, determining whether the current sum of the plant assets corresponds to the stored sum, and wherein the stored sum corresponds to the current sum. The method further includes the steps of calculating the current sum of the bad actors, computing the percentage of bad actors from the calculated sum, and determining an ARI.

In a preferred variation of the method, the step of determining the ARI further includes the steps of retrieving the stored percentage of bad actors; and computing the difference between the stored percentage of bad actors; and the current percentage of bad actors.

Still preferably, the method further includes the step of storing the ARI, the current calculated sum of the assets and the percentage of bad actors to the database.

Preferably, the method further includes the step of updating the ARI of the plant assets to a display panel.

Preferably, the method further includes the steps of determining whether the current sum of bad actors is the maximum sum and, if it is the maximum, updating it as the maximum to the database, determining whether the current sum of bad actors is the minimum sum and if it is the minimum, updating it as the minimum to the database, and updating the maximum and minimum value to the display panel.

Preferably, the method further includes the step of generating a historical trend of the ARI and updating to the display panel.

Preferably, the method further includes the step of displaying the generated historical trend on a display panel.

According to another aspect of the invention, the invention is a system for monitoring plant assets automatically comprising a calculator for calculating a sum of the plant assets to be monitored, calculating a sum of the bad actors, computing the percentage of bad actors from the calculated sum, and computing the ARI of the plant assets; a database for storing the calculated sum of plant assets, storing the computed percentage of bad actors, and storing the computed ARI of the plant assets; a comparator in communication with the calculator and the database for storing the calculated sum of the plant assets to the database, retrieving the stored sum of the plant assets from the database, determining whether the current sum of plant assets corresponds to the stored sum, storing the computed percentage of bad actors to the database, retrieving the stored percentage of bad actors from the database, determining whether the current percentage of bad actors corresponds to the stored percentage, storing the computed the ARI of the plant assets, retrieving the stored the ARI of the plant assets, and comparing the current ARI with the stored ARI.

According to another embodiment of the invention, a system for monitoring plant assets automatically comprising a calculator for calculating a sum of plant assets to be monitored, calculating a sum of bad actors, computing the percentage of bad actors, retrieving the stored percentage of bad actors, and computing the difference between the stored percentage of bad actors and the current percentage of bad actors; a database for storing the sum of plant assets calculated in the calculator, storing the computed percentage of bad actors in the calculator, storing the computed difference of percentage of bad actors in the calculator; a comparator for retrieving the stored sum of the plant assets from the database, determining whether the current sum of plant assets corresponds to the stored sum, retrieving the stored percentage of bad actors, storing the computed the difference between the stored and current percentage of bad actors, retrieving the stored the difference, and comparing the current difference with the stored difference.

### BRIEF DESCRIPTION OF THE DRAWINGS

In order that the present invention might be more fully understood, embodiments of the invention will be described, by way of example only, with reference to the accompanying drawings, in which:

FIG. 1 is a diagram showing three major layers for deriving the ARI according to one embodiment of the invention.

FIG. 2 is a flowchart illustrating one embodiment of the method of the invention.

FIG. 3 is a diagram showing one embodiment of the system of the invention.

FIG. 4 is a diagram showing an example of a display panel.

FIG. 5 is a graph showing an example of an ARI historical trend on a display panel.

### DETAILED DESCRIPTION OF THE INVENTION

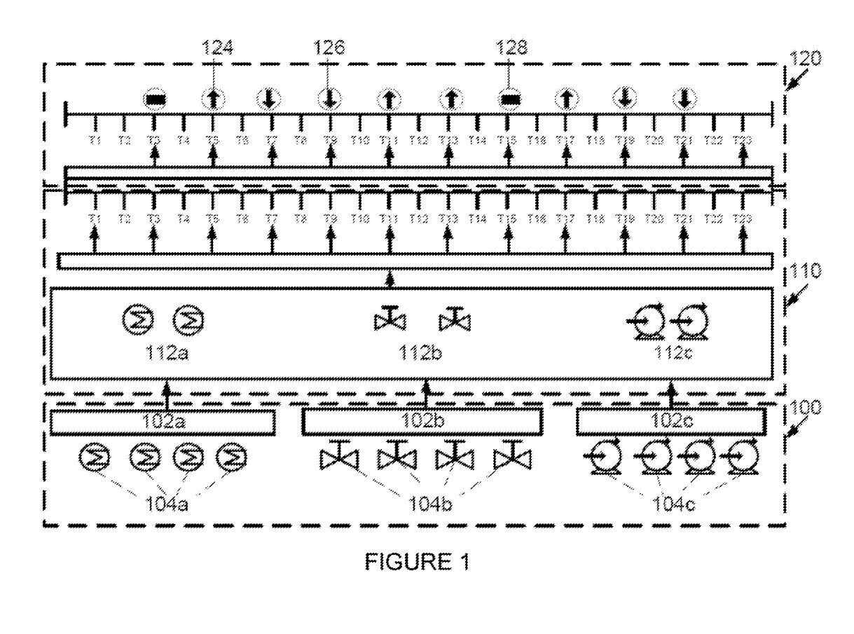

The invention is a method and system for providing an overview of the health of the plant assets by using Asset Health Risk Index (“ARI”). The ARI is an output of an automated process of continuous monitoring and diagnosing both tangible and intangible assets in a plant at predetermined time intervals. The derivation of the ARI involves three major layers—Diagnostics layer, Bad Actor Extraction Layer and ARI Layer. These layers are illustrated in FIG. 1 and explained below.

### Diagnostic Layer

The Diagnostics Layer is represented by the reference numeral 100. This layer executes the various diagnostics, such as Heat Exchanger Diagnostics 102a, Valve Diagnostics 102b and Pump Diagnostics 102c at predetermined scheduled intervals for the respective plant assets Heat Exchangers 104a, Valves 104b and Pumps 104c to generate diagnostics data. Each diagnostic has different algorithms for different assets.

### Bad Actor Extraction Layer

The Bad Actor Extraction Layer is represented by reference numeral 110. This layer executes on predetermined scheduled intervals, a summation of the diagnostics data in the Diagnostics Layer, and determines whether each asset is a Bad Actor 112a, 112b or 112c. The determination can be based on a user configured threshold value.

An example of a Bad Action Decision is explained as follows. The number of times a diagnostics identifies a problem with an asset is converted into a percentage of time the asset is in an ALARM state in a given day. For example, a diagnostic which executes on intervals of one hour is executed 24 times a day. If a problem is detected 12 times within a day, the asset is in ALARM state 50% of the total time.

Each diagnostic has one or more threshold parameters in order to determine the status of a diagnosis. When the value exceeds a predetermined threshold, the diagnostic reports the asset as a problematic one. In the above example, if the predetermined threshold for an ALARM state is 45%, the asset is determined as a Bad Actor.

Any parameter of the assets generated by the diagnostics can be used a performance measure of an asset. The performance of each asset is measured by taking any parameter alone, or in combination with others, and comparing against the respective predetermined threshold value.

The Bad Actor Extraction Layer computes the percentage of Bad Actors in a plant after determining which assets are Bad Actors. The Bad Actor Percentage is computed using the formula below:

Bad Actor Percentage=(Sum of Bad Actors)/(Sum of Plant Assets)*100

The Bad Actor Percentages for the various time intervals are stored in a database for reference.

### ARI Layer

The ARI Layer 120 reflects the change in Bad Actor Percentage. When the current Bad Actor Percentage is computed, the ARI is computed using the formula below:

ARI=(Current Bad Actor Percentage)−(Last Stored Bad Actor Percentage)

The ARI for the various time intervals are stored in a database for reference.

If the sum of Plant Assets is changed due to addition or removal of a tangible or intangible asset, the ARI is initialised.

Preferably, this layer provides a trend of the ARI for each day. The trend can be represented simply using UP ARROW 124 for a positive ARI or DOWN ARROW 126 for a negative ARI. The arrows can be in GREEN and RED respectively for a quick overview of the trend. If the ARI is ZERO, the representation can be a DASH 128.

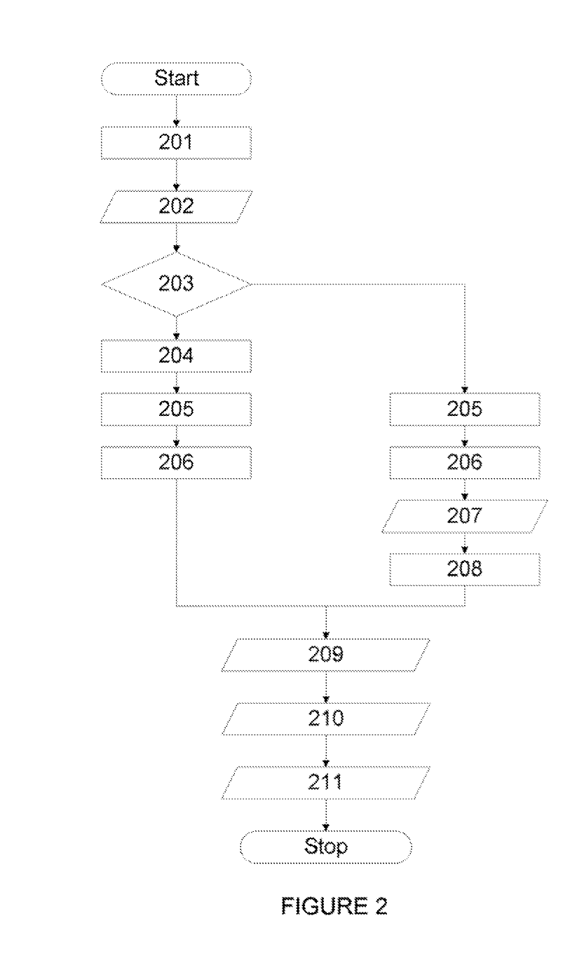

FIG. 2 illustrates one embodiment of the invention, namely a method for monitoring plant assets at predetermined intervals automatically. The sum of the plant assets to be monitored and the percentage of the bad actors in a previous monitoring interval are stored. If the monitoring is done for the first time, the sum and the percentage are initialised. Step 201 calculates the current sum of the plant assets to be monitored. A previously stored sum is retrieved in Step 202. If the plant assets are being monitored for the first time, the stored sum is zero. Step 203 determines whether the current sum of the plant assets matches with the stored sum.

If the current and stored sums do not match, Step 204 sets the Asset Health Risk Index (“ARI”) to zero. The ARI is the percentage of the assets which are rated in fair or poor condition through a periodic assessment of each asset health. Step 205 calculates the number of bad actors. The percentage of bad actors in the plant assets is computed by Step 206.

If the current and stored sums match, Step 205 which calculates the number of bad actors is performed, followed by Step 206 which computes the percentage of bad actors. Step 207 retrieves a stored percentage of bad actors. If the plant assets are being monitored for the first time, the stored percentage is zero. Step 208 determines the ARI. The ARI is determined by computing the difference between the stored percentage of bad actors and the current percentage of bad actors.

Step 209 updates the database with the current calculated ARI, the percentage of bad actors and the sum of the plant assets.

Step 210 updates the ARI of the plant assets to a display panel.

In the preferred embodiment, an additional Step 211 generates a historical trend of the ARI and displays the generated historical trend on a display panel.

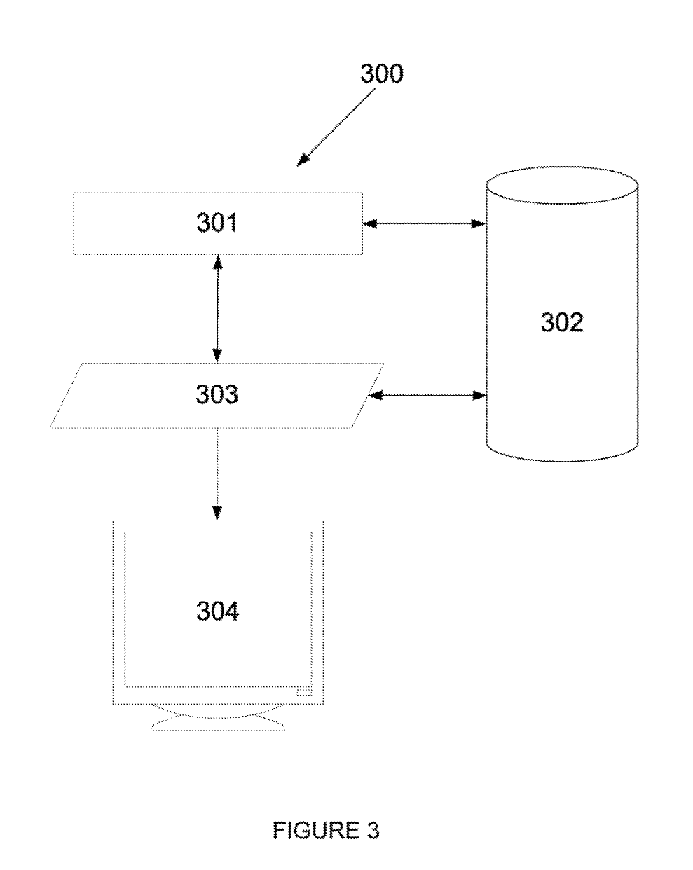

FIG. 3 illustrates another aspect of the invention. A system 300 for monitoring plant assets comprises a calculator 301, a database 302, comparator 303 and a display panel 304.

The calculator 301 performs the calculation for a sum of the plant assets to be monitored, the calculation for a sum of the bad actors, and the computation for the percentage of bad actors from the calculated sum and the ARI.

The database 302 stores the calculated sum of plant assets, the computed percentage of bad actors, the computed ARI of the plant assets from the comparator 303, and providing the stored data to the comparator when requested for retrieval.

The comparator 303 receives calculated and computed data from the calculator. It also performs the functions of storing current data to the database and retrieving the stored data from the database to the calculator for the required computations. Preferably, the calculator computes the difference between the current percentage of bad actors and the stored bad actors. The difference is updated to a display panel 304.

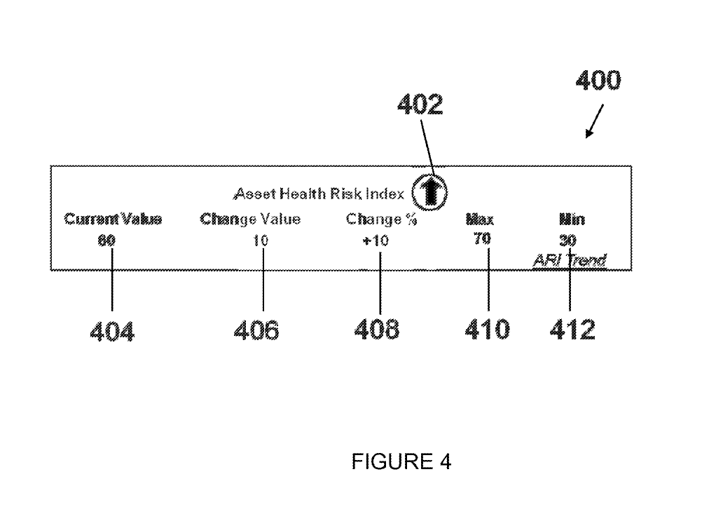

FIG. 4 illustrates an example of a display panel 400. In this example, the display panel provides the ARI indicator 402. Optionally, the other information which can be included are values for the current sum 404 of the plant assets, the difference 406 between the current sum and the stored sum, the percentage 408 of the difference, the maximum value 410, and the minimum value 412.

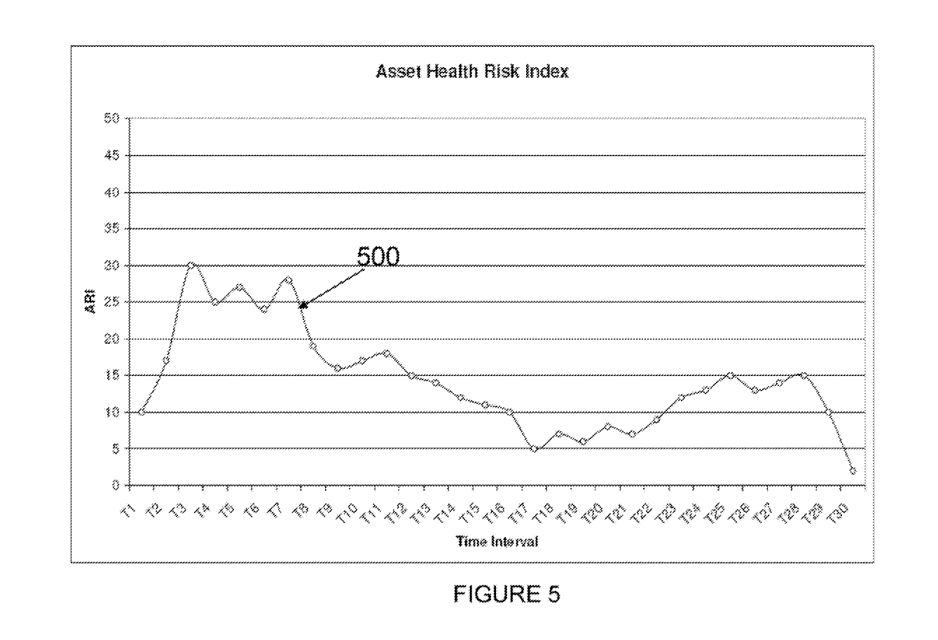

Still preferably, the comparator then retrieves a previously stored difference from the database and compares the current and stored differences. The historical trend of the differences are generated and updated to the display panel 304. FIG. 5 illustrates an example of the historical trend 500. The trend shows the ARI over a range of time intervals.

The invention aggregates the results from all diagnostic applications and allows the health of the plant to be monitored simply in a single snapshot view. This reduces the time to determine the reactive maintenance activities. The simple view eases the development of proactive maintenance methods.

By providing a view of the historical trend of the health of the plant, the effectiveness of the maintenance activities can be measured. The display is also intuitive for monitoring the fluctuations of the health of the plant.

It is to be understood that the foregoing description of several preferred embodiments is intended to be purely illustrative of the principles of the invention, rather than exhaustive thereof, and that changes and variations will be apparent to those skilled in the art, and that the present invention is not intended to be limited other than expressly set forth in the following claims.

We claim:

1. A method for monitoring plant assets automatically comprising:
calculating, by a calculator, a first sum of the plant assets;
calculating, by the calculator, a first sum of bad actors;
computing, by the calculator, a first percentage of the bad actors from the first sums of the bad actors and the plant assets;
calculating, by the calculator, a second sum of the plant assets after a predetermined interval;
determining, by a comparator, whether the second sum of the plant assets corresponds to the first sum of the plant assets,
when the second sum of the plant assets is determined to correspond to the first sum of the plant assets, calculating, by the calculator, a second sum of the bad actors;
computing, by the calculator, a second percentage of the bad actors from the second sums of the bad actors and the plant assets;
determining, by the comparator, an Asset Health Risk Index by calculating a difference between the second percentage of the bad actors and the first percentage of the bad actors for monitoring plant assets automatically.

2. A method according to claim 1 further includes storing the Asset Health Risk Index, the first and second sums of the plant assets and the first and second percentages of the bad actors to a database.

3. A method according to claim 1 further includes displaying the Asset Health Risk Index of the plant assets on a display panel.

4. A method according to claim 3 further includes
determining, by the comparator, whether the second sum of the bad actors is maximum sum of the bad actors,
when the second sum of the bad actors is determined to be the maximum sum of the bad actors, updating it as the maximum sum of the bad actors to the database,
when the second sum of the bad actors is determined to be not the maximum sum of the bad actors, determining whether it is minimum sum of the bad actors,
when the second sum of the bad actors is determined to be the minimum sum of the bad actors, updating it as the minimum sum of the bad actors to the database; and
displaying the maximum sum and the minimum sum of the bad actors on the display panel.

5. A method according to claim 4 further includes generating, by the comparator, a historical trend of the Asset Health Risk Index and displaying the historical trend on the display panel.

6. A system for monitoring plant assets automatically comprising:
a calculator for
calculating first sum and second sum of the plant assets, the second sum of the plant assets is calculated at a predetermined interval after the calculation of the first sum of the plant assets;
calculating first sum and second sum of bad actors;
computing first percentage of the bad actors from the first sum of the bad actors and the plant assets;
computing second percentage of the bad actors from the second sum of the bad actors and the plant assets;
calculating a difference between the first and the second percentages of the bad actors to determine a Asset Health Risk Index of the plant assets;
a database for
storing the first and second sums of the plant assets;
storing the first and second percentages of the bad actors;
storing the Asset Health Risk Index of the plant assets;
and
a comparator in communication with the calculator and the database for
comparing the first and second sums of the plant assets;
comparing the first and second percentages of the bad actors.

7. A system according to claim 6 further comprising a display panel for displaying the Asset Health Risk Index of the plant assets.

8. A system according to claim 6 wherein the comparator is for determining whether the second sum of the bad actors is maximum or minimum sum of the bad actors.

9. A system according to claim 8 wherein the display panel is for displaying the maximum and minimum sums of the bad actors.

10. A system according to claim 8 wherein the comparator is for generating a historical trend of the Asset Health Risk Index.

11. A system according to claim 10 wherein the display panel is for displaying the historical trend of the Asset Health Risk Index.
